(19) United States
(12) Patent Application Publication
(10) Pub. No.: US 2011/0290956 A1
(43) Pub. Date: Dec. 1, 2011

(54) Adjustable bag holding device

(76) Inventors: Rhonda Saue, Minneapolis, MN (US); Bryan Saue, Minneapolis, MN (US)

(21) Appl. No.: 13/149,182

(22) Filed: May 31, 2011

Related U.S. Application Data
(60) Provisional application No. 61/349,288, filed on May 28, 2010.

(51) Int. Cl. B65B 67/04; B23P 11/00

(52) U.S. Cl. 248/99; 29/428

(57) ABSTRACT

A plastic bag holder containing a coiled side wall and lip that creates a cavity for the insertion of items into the plastic bag. The side wall overlaps itself in a coiled pattern and its shape is maintained through a channel created by the lip. The coiled shape allows the device to be used with several sized bags allowing a user to easily fill a plastic bag cleanly and quickly.

### CROSS REFERENCE TO RELATED APPLICATIONS

This application claims the benefit of provisional patent application Ser. No. 61/349,288 filed 2010 May 28 by the present inventors.

### FEDERALLY SPONSORED RESEARCH Not Applicable

### SEQUENCE LISTING OR PROGRAM Not Applicable

1. Field of the Invention

The present invention relates to a device used to hold various sizes of a plastic bag open to enable easy and mess free filling of contents into the bag.

2. Background of the Invention

The plastic bag has become a staple of the American pantry used by individuals to store both food and non-food items. These plastic bags come in several sizes and can be composed of multiple gauges of plastic with specific sizes and gauges for a multitude of uses from enclosing a sandwich to freezing food for several months. In addition these plastic bags can be of the reclosable variety allowing a user to seal the bag multiple times during use. The advantage of a plastic bag is its compact size, ability to expand with the contents added to it, and, if reclosable, its ability to tightly seal itself preventing the intrusion of the elements.

Despite these advantages, plastic bags are difficult to fill as they collapse on themselves. It is especially difficult for one person to fill a bag as one hand is needed to hold the mouth of the bag open while the other hand is used to pour or place the contents into the bag. This process can often be difficult with individuals spilling the contents outside the bag creating a mess that requires extra clean-up. Therefore a device is needed to easily hold open a plastic bag while being filled. In addition, it is preferred that this device can adjust to be used with several sizes of bags.

### SUMMARY OF THE INVENTION

A device is provided that holds open plastic bag allowing a user to easily load contents into the plastic bag. The plastic bag holder is cylindrically shaped and overlaps itself in a coiled pattern. Material properties of elasticity and shape retention allow the plastic bag holder to expand to larger sized bag and mechanical manipulation by the user allows the device to coil itself into a smaller size for insertion into a smaller bag.

The plastic bag holder includes a side wall and lip. The side wall has an upper end, a lower end, a first end, a second end, and defines a cavity. Side wall is cylindrical and overlaps itself in a coiled pattern. The lip is in communication with the upper end of the sidewall. The lip has a wide end, a narrow end, and defines a channel. Wide end is adjacent to second end and narrow end is adjacent to first end. The narrow end will be received in the channel of the wide end as the coiled shape tightens, wherein the user will compress the coil allowing the plastic bag holder to be used for smaller sized bags. An expansion of the coil will result in a larger shape allowing the bag holder to be used for a larger bag.

In use, a user attempting to fill a plastic bag will open the bag and place the plastic bag holder into the bag. The user will appropriately size the plastic bag holder to the desired diameter to fit inside the bag by sliding and overlapping the side wall, thereby compressing the coil. The outward force of the side wall from retaining its coiled shape will be contained by the engagement of lip narrow end in the channel of lip wide end and the sides of the bag. The user will then insert the lower end into the plastic bag to the height of the lip and, due to the material properties of the plastic bag holder, the plastic bag holder will expand. The channel will help to prevent the plastic bag holder from falling into the bag and protect the plastic bag from debris during filling. After insertion into the bag, the user will then be able to easily add food contents to the bag by pouring them through the cavity created by the plastic bag holder. In the preferred embodiment of the present invention, the plastic bag holder is composed of a single piece of material that is elastic and capable of retaining its coiled shape. Preferably this material will be a molded or extruded polypropylene plastic, although other plastics or materials with similar properties may be used.

### BRIEF DESCRIPTION OF THE SEVERAL VIEWS OF THE DRAWING(S)

The accompanying drawings are included to provide a further understanding of the present invention and are incorporated in and constitute a part of this specification. The drawings illustrate exemplary embodiments of the present invention and together with the description serve to further explain the principles of the invention. Other aspects of the invention and the advantages of the invention will be better appreciated as they become better understood by reference to the Detailed Description when considered in conjunction with accompanying drawings, and wherein:

FIG. 1 is a perspective view of device, according to the present invention;

FIG. 2 is a bottom view of the device, according to the present invention;

FIG. 3 is a side view of the device, according to the present invention.

### DETAILED DESCRIPTION OF THE INVENTION

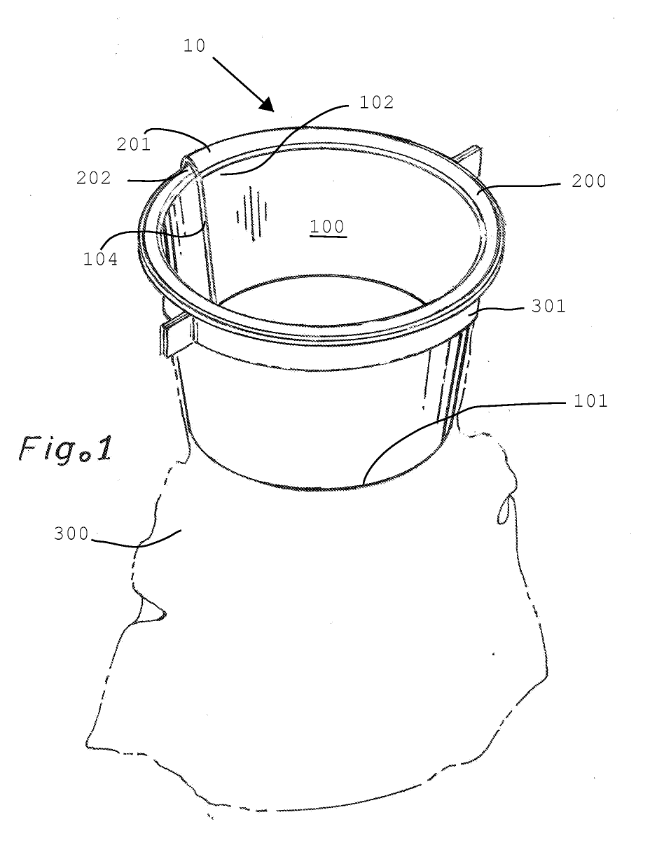

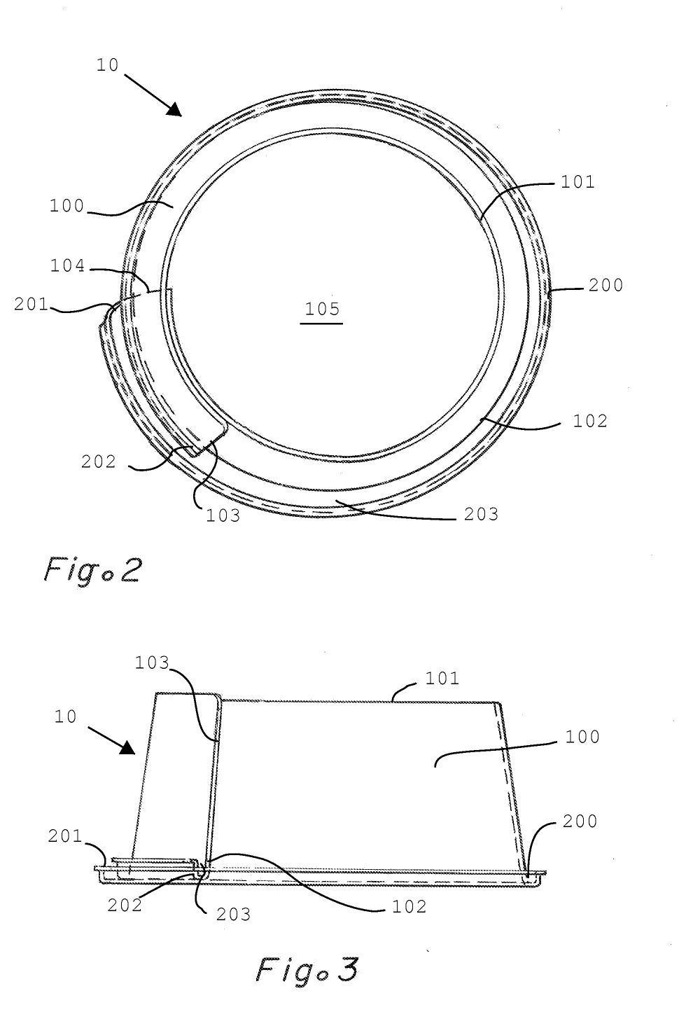

Referring now to FIGS. 1-3 there is shown an embodiment of the of the plastic bag holder of the present invention, generally designated by the reference numeral 10. Plastic bag holder 10 includes a side wall 100 and lip 200. Side wall 100 has an upper end 102, a lower end 101, a first end 103, a second end 104, and defines a cavity 105. Side wall 100 is cylindrical and overlaps itself in a coiled pattern. The lip 200 is in communication with the upper end 102. Lip 200 has a wide end 201 and narrow end 202 and defines a channel 203. Wide end 201 is adjacent to second end 104 and narrow end 202 is adjacent to first end 103. Narrow end 202 will be received in channel 203 of wide end 201 as the coiled shape tightens, wherein the user will compress the coil allowing the plastic bag holder to be used for smaller sized bags. An expansion of the coil will result in a larger shape allowing the bag holder to be used for a larger bag.

In use, a user attempting to fill a plastic bag 300 will open the bag mouth 301 and place the plastic bag holder 10 into the bag 300. The user will appropriately size the plastic bag holder 10 to the desired diameter to fit inside the bag 300 by sliding and overlapping side wall 100, thereby compressing the coil. The outward force of side wall 100 from retaining its coiled shape will be contained by the engagement of lip narrow end 202 in the channel 203 of lip wide end 201. The user will then insert lower end 101 into the plastic bag 300 to the height of lip 200 and, due to the material properties of plastic bag holder 10, the plastic bag holder 10 will expand. Channel 203 will help to prevent the plastic bag holder 10 from falling into the bag. After insertion into the bag 300, the user will then be able to easily add food contents to the bag by pouring them through the cavity created by the plastic bag holder 10.

In the preferred embodiment of the present invention, side wall 100 will have a height sufficient to be inserted fully into a standard sandwich sized plastic bag.

Preferably, this height is 7.6 cm (3 inches) as this height works for a variety of bag sizes. Preferably, bag holder 10 will have an uncoiled diameter of 17.8 cm (7 inches) as this diameter allows the bag holder 10 to cover a wide range of bag sizes from sandwich sized bags to one gallon sized bags. Preferably bag holder 10 is composed of a single piece of material that is elastic and capable of retaining its coiled shape. Preferably this material will be a molded or extruded polypropylene plastic, although other methods of manufacture and plastics or materials with similar properties may be used.

What is claimed is:

1. A bag holder for insertion into a bag comprising:
a sidewall, the sidewall having a first end and second end and defining a coiled cylindrical cavity having a diameter, wherein the cylindrical cavity diameter is adjustable by moving first end relative to second end; and
a lip, the lip in communication with the sidewall and forming a channel, the lip having a wide end adjacent to the second end and narrow end adjacent to the first end, wherein the narrow end will be received in the wide end as the sidewall is coiled.

2. The bag holder of claim 1, wherein the bag holder is a single piece.

3. The bag holder of claim 1, wherein the bag holder is plastic.

4. A method for inserting a bag holder into a bag, the method comprising:
adjusting a coiled cylindrical sidewall having a first end and second end and defining a cavity to the proper diameter by overlapping first end and second end;
inserting a lower end of the coiled cylindrical sidewall into the bag to the depth of a lip disposed on the upper end of the coiled cylindrical sidewall; and
releasing the bag holder, wherein the bag holder will expand allowing a user to fill the bag through the cavity.

5. The bag holder of claim 4, wherein the bag holder is a single piece.

6. The bag holder of claim 4, wherein the bag holder is plastic.
